(19) United States
(12) Patent Application Publication
(10) Pub. No.: US 2008/0236693 A1
(43) Pub. Date: Oct. 2, 2008

(54) EXHAUST PIPE ASSEMBLY

(76) Inventors: Norman Everett Muzzy, Cedar Falls, IA (US); Jason Michael Edgington, Cedar Falls, IA (US)

Correspondence Address: DEERE & COMPANY, ONE JOHN DEERE PLACE, MOLINE, IL, 61265, US

(21) Appl. No.: 11/693,794

(22) Filed: Mar. 30, 2007

(51) Int. Cl. F16L 55/00

(52) U.S. Cl. 138/108; 138/112

(57) ABSTRACT

The invention relates to an exhaust pipe assembly. There is a need for an exhaust pipe assembly which transmits less noise to the environment. The exhaust pipe assembly includes a hollow exhaust pipe, and a hollow shield which surrounds at least a portion of the pipe. The shield is supported from and separated from the pipe by a plurality of elastomeric support elements which are interposed between the pipe and the shield. Each support element includes a larger body positioned between the pipe and the shield, and a smaller stem which projects from the body and extends into a bore formed in the shield. Each support element is preferably formed by injecting an elastomeric material through a corresponding one of the bores to form the body in the space between the pipe and the shield.

### FIELD OF THE INVENTION

The present invention relates to an exhaust pipe assembly.

### BACKGROUND OF THE INVENTION

Conventional exhaust pipe shields are secured to the exhaust pipe by various methods. Such shields are typically mounted by welding or mechanically fastening the shield to the inner pipe. A known shield mounting mechanism is described in U.S. Pat. No. 5,036,947 issued to Metzger in 1991. Such mounting mechanisms result in a rigid connection between the exhaust pipe and the shield. This rigid connection transmits noise from the inner pipe to the outer shield.

### SUMMARY OF THE INVENTION

Accordingly, an object of this invention is to provide a quieter exhaust pipe assembly.

This and other objects are achieved by the present invention, wherein an exhaust pipe assembly includes a hollow exhaust pipe, and a hollow shield which surrounds at least a portion of the pipe. The shield is supported from and separated from the pipe by a plurality of elastomeric support elements which are interposed between the pipe and the shield. Each support element includes a larger body positioned between the pipe and the shield, and a smaller stem which projects from the body and extends into a bore formed in the shield. Each support element is preferably formed by injecting an elastomeric material through a corresponding one of the bores to form the body in the space between the pipe and the shield.

### BRIEF DESCRIPTION OF THE DRAWINGS

FIG. 1 is a perspective view of an exhaust pipe assembly embodying the invention;

FIG. 2 is an enlarged perspective and partial sectional view of the exhaust pipe assembly of FIG. 1; and

FIG. 3 is a perspective view of an elastomeric support element for the exhaust pipe assembly of FIG. 1.

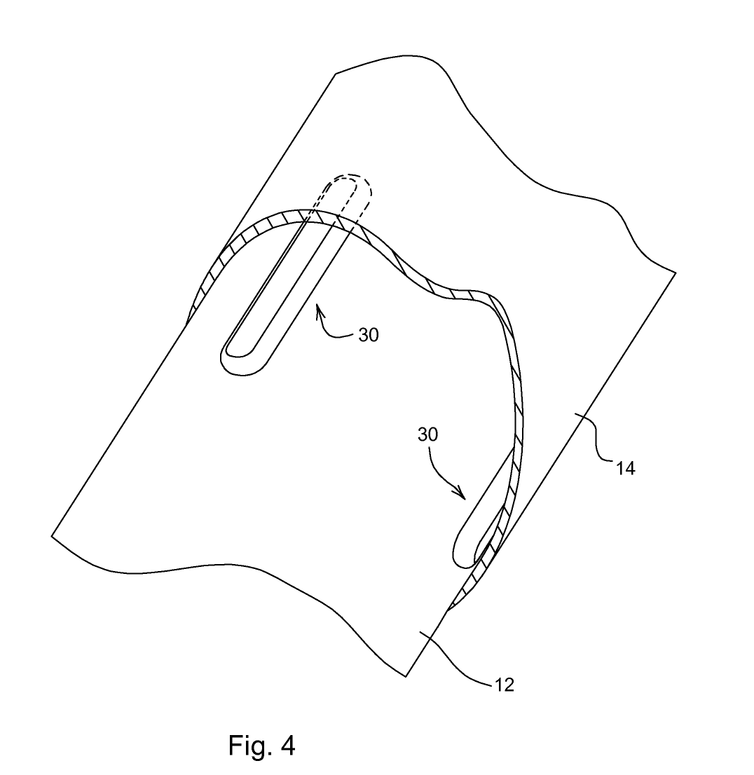

### DESCRIPTION OF THE PREFERRED EMBODIMENT

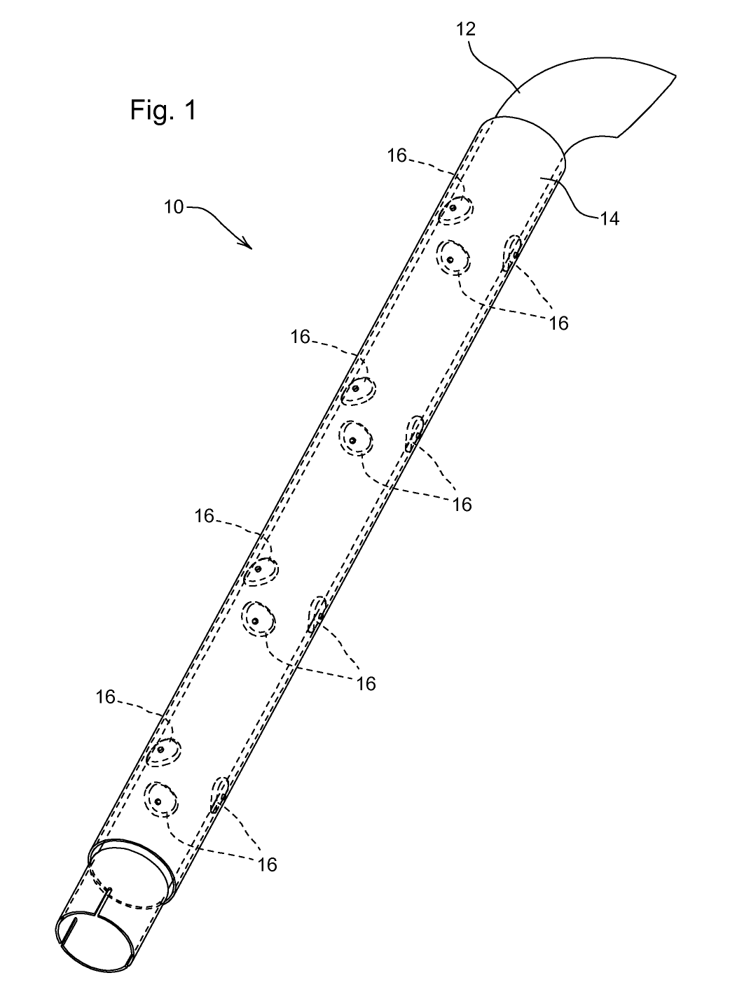

Referring to FIG. 1, an exhaust pipe assembly 10 includes an elongated hollow exhaust pipe 12, and an elongated hollow shield 14 which surrounds at least a portion of the pipe 12. The shield 14 is supported from and separated from the pipe 12 by a plurality of elastomeric support elements 16 which are interposed between the pipe 12 and the shield 14.

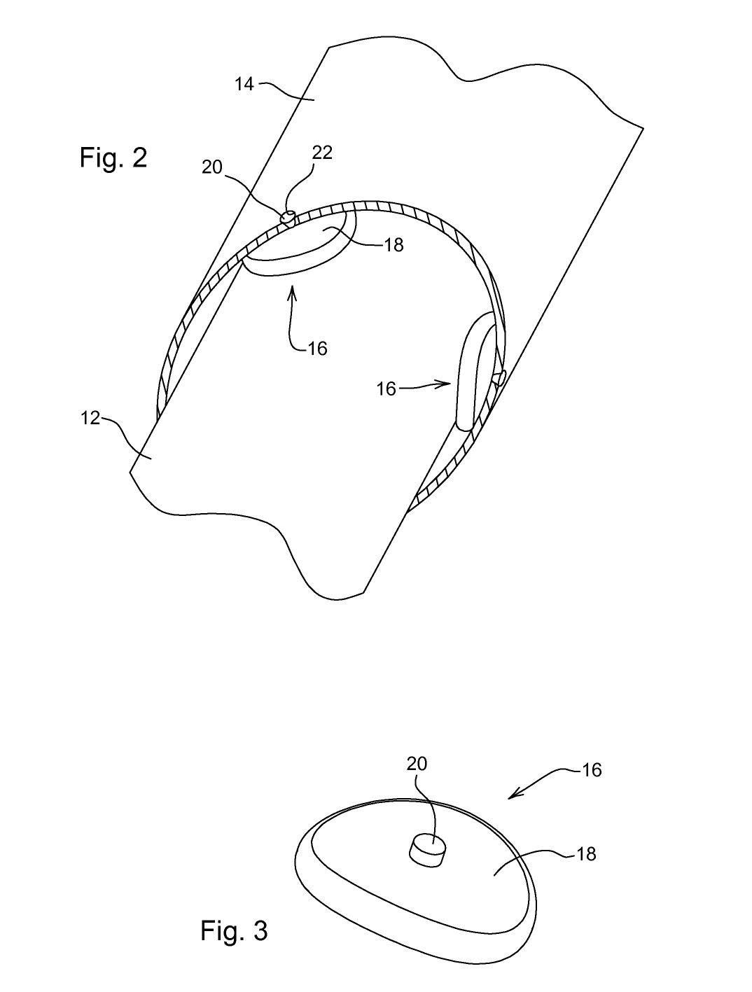

As best seen in FIG. 2, each elastomeric support element 16 includes a larger body 18 positioned between the pipe 12 and the shield 14 and a smaller stem 20 which projects from the body 18 and extends into a bore 22 formed in the shield 14.

Each elastomeric support element 16 is preferably formed by injecting an elastomeric material through a corresponding one of the bores 22 to form the elastomeric body 18 in the space between the pipe 12 and the shield 14.

The elastomeric material may be high temperature RTV silicone adhesive. The suspension element could also be a foam tape or molded element of some type.

The elastomeric material supports 16 eliminate the need for a mechanical and/or rigid fastening and lowers the amount of noise transmitted from the assembly 10 and reduces noise at the operators ear. The frequency range of the sound that is attenuated by this device works well with the peak energy ranges emitted by internal combustion engines. The method of injecting or applying the elastomeric element allows the parts to be painted prior to assembly. The appearance is not affected by welds or mechanical fasteners.

The number of points where the elastomeric element is applied and the thickness and dimensions of the outer tube can be varied to optimize the attenuation characteristics.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

1. An exhaust pipe assembly, comprising:
an elongated hollow exhaust pipe;
an elongated hollow shield surrounding at least a portion of the pipe; and
a plurality of elastomeric support elements interposed between the pipe and the shield and supporting the shield with respect to the pipe.

2. The exhaust pipe assembly of claim 1, wherein:
each elastomeric support element comprises a larger body positioned between the pipe and the shield and a smaller stem which projects from the body and into a bore formed in the shield.

3. The exhaust pipe assembly of claim 1, wherein:
the shield includes a plurality of bores extending radially therethrough;
each elastomeric support element is formed by injecting an elastomeric material through a corresponding one of the bores to form an elastomeric body in a space between the pipe and the shield.

4. The exhaust pipe assembly of claim 3, further comprising:
an elastomeric stem is formed in each of the bores.

5. The exhaust pipe assembly of claim 1, wherein:
each elastomeric support element comprises an elongated body positioned between the pipe and the shield.
